(19) United States
(12) Patent Application Publication
(10) Pub. No.: US 2010/0241648 A1
(43) Pub. Date: Sep. 23, 2010

(54) IMAGE PROCESSING APPARATUS

(75) Inventors: Masayuki ITO, Nagoya-shi (JP); Shin Ohba, Toyokawa-shi (JP); Kana Yamauchi, Toyohashi-shi (JP); Toshihisa Motosugi, Okazaki-shi (JP); Jiro Goto, Toyokawa-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 12/729,888

(22) Filed: Mar. 23, 2010

(30) Foreign Application Priority Data
Mar. 23, 2009 (JP) 2009-069939

(51) Int. Cl. G06F 17/30; G06F 3/048

(52) U.S. Cl. 707/765; 707/769; 715/764; 707/E17.014; 707/E17.017

(57) ABSTRACT

An image processing apparatus which executes a predetermined image processing using a data file stored in a data storage device. The image processing apparatus includes: an external interface unit that detachably connects with the data storage device; an input unit that accepts a setting input for a setup item relating to the predetermined image processing; a setting input detection unit that detects the setting input inputted through the input unit; a search condition generating unit that generates a search condition based on a setting value that is set for the setup item relating to the predetermined image processing, when the setting input detection unit has detected the setting input; an execution instructing unit that instructs a search unit to execute a data file search when the setting input detection unit has detected the setting input; the search unit that, in accordance with the instructions from the execution instructing unit, executes a data file search for a data file stored in the data storage device to output a search result based on the search condition that is generated by the search condition generating unit; and a display unit that displays the search result of the data file search.

This application is based on an application No. 2009-069939 filed in Japan, the contents of which are hereby incorporated by reference.

### BACKGROUND OF THE INVENTION

1. Field of the Invention

The present invention relates to an image processing apparatus, and more particularly, to an image processing apparatus which executes printing processing using a data file stored in a data storage device.

2. Description of the Related Art

In recent years, not only a conventional information processing apparatus such as a personal computer, an image processing apparatus such as a printer and a digital complex machine is also provided with advanced information processing capability enough to work singly as an information processing apparatus.

In such an image processing apparatus, a user is able to connect an image processing apparatus with a data storage device directly via a connection port or indirectly through a network, and to cause the image processing apparatus to execute image processing using a data file stored in the data storage device. For example, a user may connect the data storage device with a digital complex machine (also referred to as an “MFP” (Multi-Function Peripheral), hereinafter), which is one example of such an image processing apparatus, and manipulate the digital complex machine so as to cause the digital complex machine to print out an image stored in the data storage device in the form of a data file.

Examples of such data storage devices that can be connected to the digital complex machine (MFP) include: a USB memory (USB flash drive); an SD memory card (SD card); Compact Flash (registered trademark) (CF card); a flexible disk (FD); a Compact Disc (CD); a digital versatile disc (DVD); a magneto-optical disc (MO); a hard disk; and the like. In the present application, such a data storage device is also referred to as a “media device”. A maximum data storage capacity of an existing media device has dramatically been increased, and it makes possible to store enormous numbers of data files in a single media device.

It is understood that data files of various types of data formats can be stored in a single media device. Hence, it is thinkable that a variety of data files such as data files of written reports for business use and image data pieces for private use would be mixed together in a single media device. The MFP manages the data files in the media device by means of a file name assigned to each data file and a hierarchical structure (such as file paths) of folders (directories), in which data files are stored. File names and file paths are used also when a user specifies a data file. However, in the situation where enormous numbers of data files are stored in a media device, it is practically impossible for a user to keep a file name or a file path of each file stored in the media device in his/her memory.

Accordingly, an information processing apparatus or an image processing apparatus is typically provided with functions such as: a file listing function for displaying a list of data files stored in a media device by grouping them in folder units and presenting the group of data files to the user; and a file search function for searching a data file using information of a specific keyword (search key) specified by the user and stored information being associated with data files.

The user tries to pinpoint an intended data file by properly using those functions.

For example, when a user using the file listing function, he/she tries to find an intended data file from a data files list of a specific folder, in which the intended data file, would possibly be therein, by specifying the folder to display the folder's data files list folder and sort the list using the management data stored and associated with each data file such as a time stamp.

Alternatively, for example, when a user using the file search function, he/she inputs into an information processing apparatus a character string as a search key, which would be expected to be a part of an intended data file's name and tries to find the intended data file from a displayed list of data files each of which file name includes the search key.

However, with the file listing function and the file search function described above, it is not always possible to efficiently identify data file. This is because the information that the user keeps partly in his/her mind about the intended data file's name and the folder which involves the data file is often incorrect.

In particular, regarding a data file (of image data, for example) that is automatically generated and stored in a media device by an information device (a digital camera, for example), the name of the data file and a destination folder to save the file are usually automatically determined by the information device, and there may be a case where the user does not know at all the information about how the data file is managed in the media device.

As another aspect, character entry means provided on a typical image processing apparatus such as a digital complex machine is often a software key that is temporarily displayed on an operation panel as needed. Accordingly, even if the user correctly remembers the file name of the data file, it may take time for the user to enter a character string (search key). Thus, the conventional data file search function based on the entry of a character string does not always work efficiently in the image processing apparatuses such as digital complex machines.

JP 2008-022336 A discloses an image forming apparatus, a method, and a program each of which is characterized in an image data search refinement technique.

The image forming apparatus according to JP 2008-022336 A is provided with a function of generating a compound condition using setup items relating to printing (printing mode, printing paper size, and number of printing pages) out of the setup items for the image forming apparatus, and of displaying a list of data files that satisfy the compound condition (filtering function), for example.

In the invention of JP 2008-022336 A, the filtering function starts to operate only after when “file selection button” (see, FIG. 8 of the drawing of JP 2008-022336 A, for example) is pressed down. Briefly, in the invention of JP 2008-022336 A, the pressing down of the file selection button by the user is used as a trigger for starting the filtering function.

Furthermore, a compound condition used for the filtering is the compound condition generated based on the setup items relating to printing being set in the image forming apparatus at the time when the user presses down the file selection button.

Accordingly, in the invention of JP 2008-022336 A, even if the user modifies a part of the setup items relating to printing, the filtering result that reflects the modification may not be presented to the user until the user presses down the file selection button again. In order to change the compound condition used for the filtering in the configuration disclosed in JP 2008-022336 A, the user is required to firstly cancel a file selection screen (see, FIG. 11 of the drawing of JP 2008-022336 A, for example), secondly return to a function selection screen (see FIG. 6 of the drawing of JP 2008-022336 A, for example) to thirdly select functions (such as the printing mode described above) to determine various settings (including the printing paper size and the number of printing pages as described above) in a screen for setting function details (see FIGS. 8, 9, and 10 of the drawing of JP 2008-022336 A, for example) and finally press the file selection button. This cannot avoid requiring complicated procedures to the user. Moreover, in the invention of JP 2008-022336 A, the user is not able to arbitrarily select a set of a setup item(s) to be included in the compound condition for the filtering.

Consequently, when the intended data file is not included in the result of the filtering, the operations required to the user next is adversely cumbersome, and, in some cases, it is adversely unclear for the user what kind of operation should be carried out next to find the intended data file.

### SUMMARY OF THE INVENTION

In view of the problems inherent in the conventional technique as described above, it is an object of the present invention to provide an image processing apparatus which allows a user to find an intended data file stored in a media device (data storage device), and execute image processing using the file quickly. Accordingly, the present invention improves operability of the image processing apparatus, and thus improving productivity and facilitating effective use thereof.

In one aspect of the present invention, there is provided an image processing apparatus which executes a predetermined image processing using a data file stored in a data storage device. The image processing apparatus includes: an external interface unit that detachably connects with the data storage device; an input unit that accepts a setting input for a setup item relating to the predetermined image processing; a setting input detection unit that detects the setting input inputted through the input unit; a search condition generating unit that generates a search condition based on a setting value that is set for the setup item relating to the predetermined image processing, when the setting input detection unit has detected the setting input; an execution instructing unit that instructs a search unit to execute a data file search when the setting input detection unit has detected the setting input; the search unit that, in accordance with the instruction from the execution instructing unit, executes a data file search for a data file stored in the data storage device to output a search result based on the search condition that is generated by the search condition generating unit; and a display unit that displays the search result of the data file search.

In a further aspect of the present invention, there is provided an image processing method in an image processing apparatus which executes a predetermined image processing using a data file stored in a data storage device. The image processing method includes: accepting a setting input for a setup item relating to the predetermined image processing by an input unit; detecting the setting input inputted through the input unit by a setting input detection unit; generating a search condition based on a setting value that is set for the setup item relating to the predetermined image processing, when the setting input detection unit has detected the setting input; instructing a search unit to execute a data file search by an execution instructing unit when the setting input detection unit has detected the setting input; executing a data file search for a data file stored in the data storage device by the search unit, in accordance with the instruction from the execution instructing unit, to output a search result based on the search condition that is generated by the search condition generating unit; and displaying the search result of the data file search by a display unit.

In a yet further aspect of the present invention, there is provided a computer-readable medium having stored thereon computer executable instructions which, when executed by a computer of an image processing apparatus which executes a predetermined image processing using a data file stored in a data storage device, perform: causing an input unit to accept a setting input for a setup item relating to the predetermined image processing; causing a setting input detection unit to detect the setting input inputted through the input unit; causing a search condition generating unit to generate a search condition based on a setting value that is set for the setup item relating to the predetermined image processing, when the setting input detection unit has detected the setting input; causing an execution instructing unit to instruct a search unit to execute a data file search when the setting input detection unit has detected the setting input; causing the search unit to, in accordance with the instruction from the execution instructing unit, execute a data file search for a data file stored in the data storage device to output a search result based on the search condition that is generated by the search condition generating unit; and causing a display unit to display the search result of the data file search.

### BRIEF DESCRIPTION OF THE DRAWINGS

The above and further objects and novel features of the present invention will more fully appear from the following detailed description when the same is read in connection with the accompanying drawings, and in which:

FIG. 1 is a perspective view of a digital complex machine according to an embodiment of the present invention and a media device;

FIG. 2 is an example of file attribute information of a data file in the media device;

FIG. 3 is a conceptual diagram of a file search refinement function of the digital complex machine according to the embodiment of the present invention;

FIG. 4 is a block diagram of a hardware configuration of the digital complex machine according to the embodiment of the present invention;

FIG. 5 is a block diagram of a functional configuration of the digital complex machine according to the embodiment of the present invention;

FIGS. 6A and 63 are flow charts of the file search refinement function of the digital complex machine according to the embodiment of the present invention;

FIG. 7 is an example of a structure of a user interface unit of the digital complex machine (print setup is not determined);

FIG. 8 is an example of a structure of the user interface unit of the digital complex machine (after a paper feed tray is selected);

FIG. 9 is an example of a structure of the user interface unit of the digital complex machine (after the paper feed tray is selected, and a magnification ratio is ready for being selected);

FIG. 10 is an example of a structure of the user interface unit of the digital complex machine (after the paper feed tray and the magnification ratio are selected, and a color mode is ready for being selected);

FIG. 11 is an example of a structure of the user interface unit of the digital complex machine (the paper feed tray, the magnification ratio, and the color mode are selected, and a stapling position is ready for being selected);

FIG. 12 is an example of a structure of the user interface unit of the digital complex machine (after a file is selected);

FIG. 13 is an example of a structure of the user interface unit of the digital complex machine (in a situation where an inconsistency between the selected file and the print setup being occurred);

FIG. 14 is an example of a structure of the user interface unit of the digital complex machine (an example of a list of files satisfying a condition);

FIG. 15 is an example of a structure of the user interface unit of the digital complex machine (an example of a display of preview of the files satisfying the condition);

FIG. 16 is an example of a structure of the user interface unit of the digital complex machine (deselected print setup items are hidden (grayed out) due to no file satisfying the condition);

FIG. 17 is an example of a structure of the user interface unit of the digital complex machine (in a situation where no file satisfies the conditions);

FIG. 18 is an example of a structure of the user interface unit of the digital complex machine (the color mode is ready for being selected);

FIG. 19 is an example of a structure of the user interface unit of the digital complex machine (after the color is selected, and the paper feed tray is ready for being selected); and

FIG. 20 is an example of a structure of the user interface unit of the digital complex machine (another example of a situation where the paper feed tray is ready for being selected after the color is selected).

It is to be expressly understood, however, that the drawings are for the purpose of illustration only and are not intended as definitions of the limits of the invention. Preferred embodiments of the present invention are described in more detail below referring to these accompanying drawings.

### DETAILED DESCRIPTION OF THE PREFERRED EMBODIMENTS

An MFP according to an embodiment of the present invention is accomplished based on the idea of the inventors below. When a user carries out printing processing of a data file stored in a media device (USB memory, for example) using an MFP, it is considered that the user often holds a clearer picture of a finished printed matter using the data file (such as a number of pages, printing paper size (original size or image size), color setup (black-and-white, two-color, or full-color), magnification ratio, double sides/single side, and finishing setup (setting for stapling processing and its position and setting for punching processing and its position)), rather than information such as a file name and a file path of the data file in the media device. Further, it is also considered that probability that the picture about the finished printed matter held by the user in mind would be reflected upon the setup configuration of the MFP made by the user is quite high. Based on these considerations, the inventors came up with an idea that carrying out search refinement of data files based on the setup configuration of the MFP made by the user, in other words, only presenting data files having attributes consistent with the setup configuration to the user, can make it easier for the user to find an intended data file from a media device in which an enormous number of data files are stored, and thus it can be expected that operability, productivity and the like of the MFP are improved. Moreover, by generating thumbnail images of a small number of data files as a result of data file refinement as described above and giving a preview display of these images, even if the user has no information at all about the intended data file such as a file path, a file name, and a file format, the user can find the intended data file quickly.

According to the MFP of the present embodiment accomplished based on such an idea, a search condition for searching a data file in a media device is automatically generated based on a setup configuration entered by the user, and a data file search is automatically executed by this search condition, thereby presenting a search result to the user. In this manner, the MFP assists the user to find an intended data file out of a group of data files in the media device. The MFP according to the present embodiment executes a search, based on a search condition that is automatically generated, for attribute information of data files (header information in data files or data file management information generated in association with data files, for example) in a media device. Further, the MFP can automatically regenerate a search condition and carry out a data file search again every time when the user inputs the setup configuration, that is, every time when the setup configuration is modified, and notify the user of the search result as needed.

Such an MFP according to the present embodiment uses the setup configuration of the MFP set by the user (as described above, probability that the picture of the finished printed matter that the user holds in mind may be reflected upon the “setup configuration” is quite high) to generate a condition for the data file search, and carries out the search refinement of the data files in the media device (data file search) based on the condition. Accordingly, the MFP according to the present embodiment is able to refine the search for the data file even when the user does not have any information regarding the file name and the format of the data file at all. This is also advantageous when searching for a data file that has been automatically generated by an information processing device such as a digital camera, and automatically stored in a media device.

As described above, the MFP according to the present embodiment displays in a list a result of the data file search in a user interface. Accordingly, every time when the user modifies the setup configuration, the user is immediately able to see the result of the data file search that reflects the modification, without any special operation to perform a new search. According to the MFP of the present embodiment, for a setup item that the user does not wish to include as a condition for the data file search, the user can make an input for the setup item after finding the data file. Therefore, with the MFP according to the present embodiment, it is possible to automatically generate a condition for the data file search and execute the data file search only based on the setup items that the user arbitrarily and selectively set. Further, according to the MFP of the present embodiment, when there is inconsistency between data characteristics (attribute values) of a data file selected by the user and the setup configuration inputted after the selection, it is possible to prompt the user to modify the setup configuration of the printing processing of the selected data file by issuing an alert to the user.

With such characteristics, according to the MFP of the present embodiment, the user is able to perform a search for a data file quickly by selecting a search condition of the data file freely in a simple manner. Thus, the MFP according to the present embodiment provides advantageous effects of improvement of operability as well as utilization efficiency and productivity.

Further, according to the MFP of the present embodiment, as the user can freely select the setup items included in the search condition, it is possible to avoid, to a maximum extent, such a situation in which an enormous number of data files are presented in the result of the data file search or in which the number of the data files that satisfy the search condition is zero. Moreover, as the user can follow a process of change in a search result that is displayed in the user interface and changes in accordance with the modification made to the data file search condition, the user can easily recognize incorrectness of the picture of the finished printed matter that the user holds in mind. Accordingly, it is possible to modify the incorrectness in the print setup made by the user and carry out the printing based on the correct setting. Therefore, according to the MFP of the present embodiment, misprinting can also be reduced.

The following describes the embodiment of the present invention in detail.

The image processing apparatus according to the embodiment of the present invention is a digital complex machine (MFP). A digital complex machine (MFP) is an image processing apparatus having at least two functions out of printer, facsimile, photocopier, and scanner functions, for example. The MFP according to the present embodiment is connectable with a data storage device (media device) directly via its connection port, or indirectly via a network. As the media device, a USB memory, an SD memory card (SD card), a Compact Flash (registered trademark) (CF card), an FD, a CD, a DVD, an MO disc, a hard disk and the like may be used.

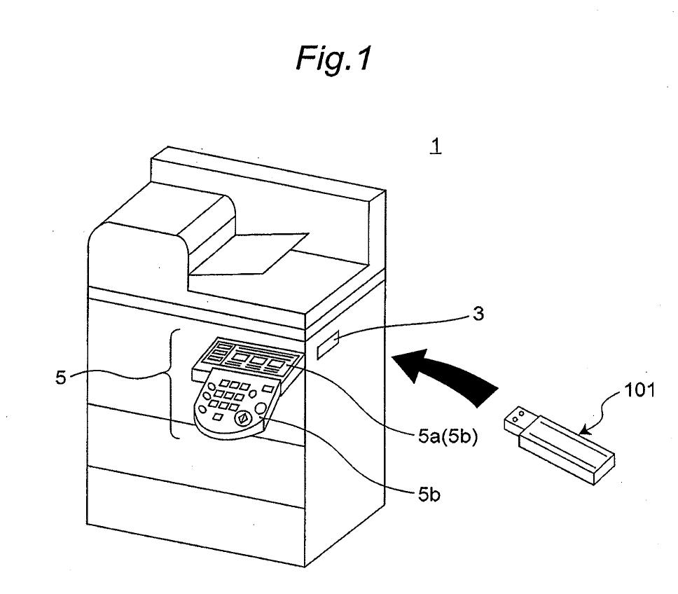

FIG. 1 is a perspective view of an MFP 1 according to the present embodiment and a media device 101 (USB memory). The MFP 1 is provided with an external interface unit 3. The external interface unit 3 is connectable with the media device 101 (USB memory). The MFP 1 is also provided with a user interface unit 5. The user interface unit 5 includes a display unit 5a and an input unit 5b. The display unit 5a is configured with an LCD having a touch panel, and this touch panel functions as a part of the input unit 5b.

The MFP 1 is able to, using a data file (image data file, for example) stored in the media device 101, execute a predetermined process (printing processing of an image of the image data file, for example). In this case, the data file is not limited to an image data file. When the predetermined process is printing processing, the data file may be any data file that can be printed out (such as document data). While it is described that the predetermined process may be printing processing based on the data file in the present embodiment, this does not mean that the predetermined process according to the present invention is limited to the printing processing.

The MFP 1 is able to acquire an attribute value that will be described below for each data file stored in the media device (USB memory) 101 connected therewith as needed.

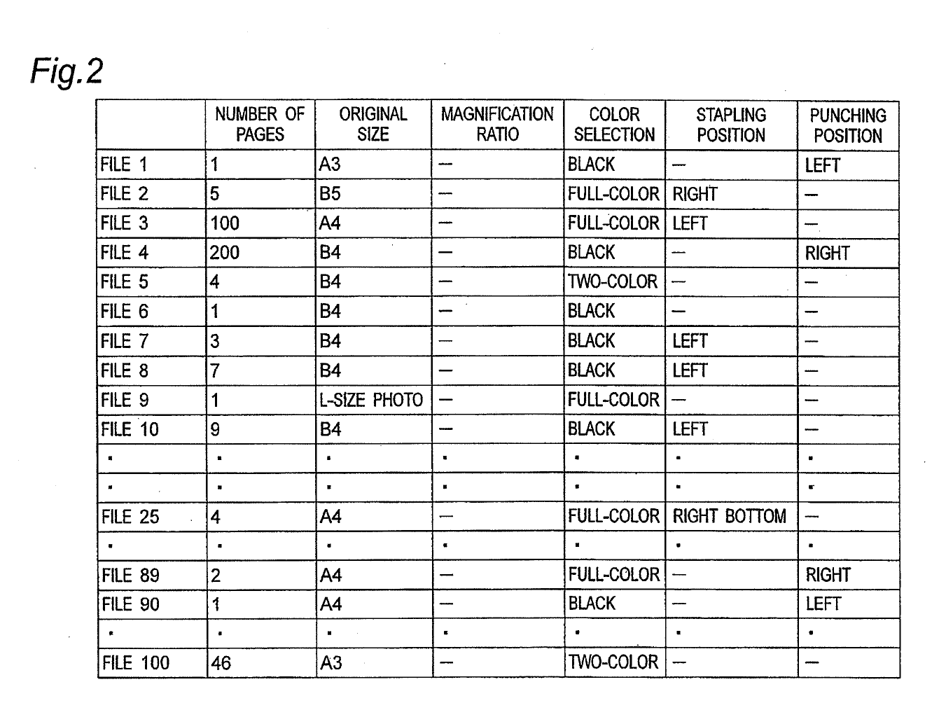

FIG. 2 is a diagram of an example of data files (files 1 to 100 in this figure) stored in the media device (USB memory) 101 and their respective attribute values. In the figure, examples of the attributes of a data file include:

a number of pages of an image, document, and the like (hereinafter referred to as “image and the like”) included in the data file;

an original size that is previously set for the data file for printing the image and the like (printing paper size);

a magnification ratio for enlargements and reductions that is previously set for the data file for printing the image and the like;

a color setting selection that is previously set for the data file for printing the image and the like;

a stapling position that is previously set for the data file for printing the image and the like; and

a punching position (position of punching processing) that is previously set for the data file for printing the image and the like. For example, an attribute value of the attribute “number of pages” of the “file 3” is “100”. Similarly, an attribute value of the attribute “original size” is “A4”, and an attribute value of the attribute “color selection” is “full-color”, and an attribute value of the attribute “stapling position” is “left”. For the “file 3”, attribute values are not set for the attributes “magnification ratio” and “punching position”. These attributes and attribute values may be included in a part of a data file (header, for example), or may be recorded independently in the media device 101 and the like in association with the data file. Further, the attributes and the attribute values are not limited to the attributes and the attribute values that are assigned for the purpose of printing the image and the like. The MFP 1 treats each attribute of a data file appropriately, for example, by giving priority to a value of its own setup item related to an attribute when the attribute value is not assigned.

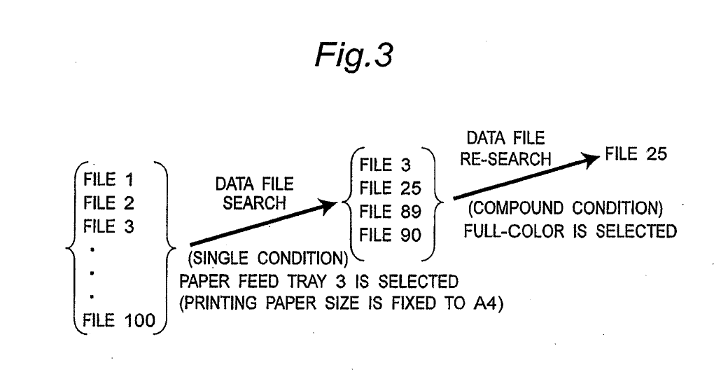

FIG. 3 is a conceptual diagram illustrating a flow of the data file search and re-search carried out by the MFP 1 according to the present embodiment. It is assumed that, in the media device 101, 100 data files from the file 1 to the file 100 are stored (see the leftmost column in FIG. 3). In such circumstance, for example, assuming that a setting input to select a paper feed tray 3 as a tray of sheets used for printing is made to the MFP 1. At this time, if the paper feed tray 3 contains sheets of paper of A4 size, the MFP 1 automatically generates a search condition “the value of the attribute “original size” is “A4””, and refines the search of data files in the media device. Parentheses { } in the middle of FIG. 3 indicate data files that satisfy the search condition “the value of the attribute “original size” is “A4””. In this manner, the MFP 1 finds data files that satisfy the setup configuration based on the setting input of the printing processing made by the user, and presents the files to the user. At this time, the user can select at least one data file among the data files that are being presented, and instruct the MFP 1 to execute the printing processing. Alternatively, the user can make a further setting input of the printing processing to the MFP 1. For example, if the user inputs a color setup relating to printing to the MFP 1 (for example, full-color), the MFP 1 automatically generates again, based on the setup configuration that is currently set, a compound search condition “the value of the attribute “original size” is “A4” and the value of the attribute “color selection” is “full-color””, and again refines the search of data files in the media device. In the rightmost column in FIG. 3, a data file (file 25) that is left as a result of the data file re-search is shown. As a result of two automatic searches, the user can easily see that only the data file 25 satisfies the two items of the setup items (the printing paper size and the color selection). During the two searches, the user does not need to worry about setting the conditions for the data file search. The user has simply made the setting input according to a picture in mind about a finished printed matter.

### <Hardware Configuration of MFP>

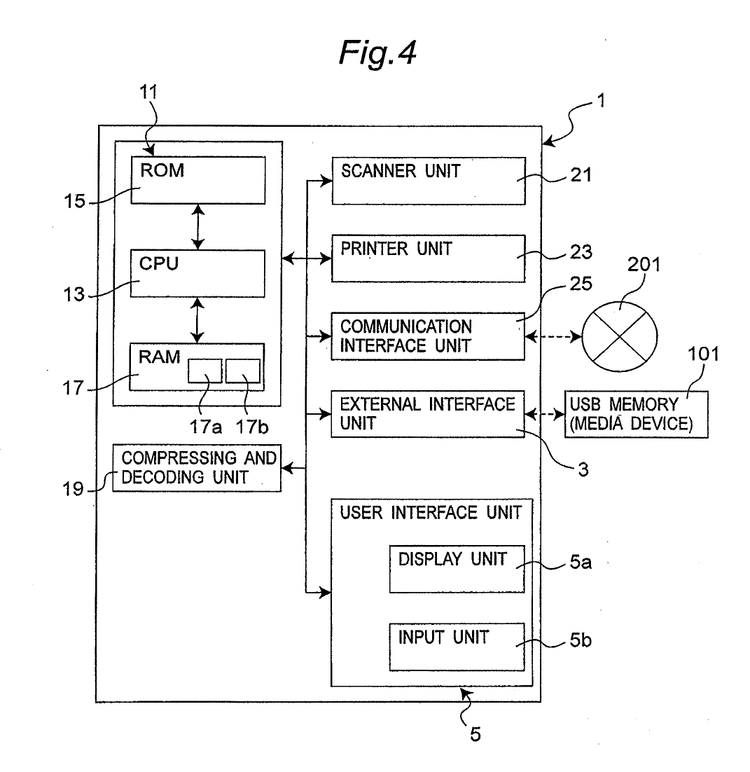

FIG. 4 is a block diagram illustrating an outline of a hardware configuration of the MFP 1 according to the present embodiment. The MFP 1 includes therein a central processing unit (CPU) 13, a read only memory (ROM) 15, and a random access memory (RAM) 17. The CPU 13, the ROM 15, and the RAM 17 configure a computer main part 11 of the MFP 1. Further, the RAM 17 is provided with a working memory 17a and an image memory 17b. The working memory 17a configures a memory area for recording data required for image processing and the like, and the image memory 17b configures a memory area for temporarily storing an image data generated by a scanner unit 21, or externally provided via a communication interface unit 25. The working memory 17a and the image memory 17b may be configured by a single volatile memory. Further, the computer main part 11 of the MFP 1 is connected via a data bus to other different hardware components in a manner that data can be received and transmitted between each other. As a hardware component, the MFP 1 is also provided with a compressing and decoding unit 19 that compresses and decodes image data, the scanner unit (image input unit) 21 that optically reads an image and generates electronic data, a printer unit 23 (image output unit) that prints the image expressed by the electronic data onto a predetermined sheet of paper, the communication interface unit 25 that communicates with external devices via a network 201 (such as LAN, USB, or telephone lines), the external interface unit 3 that can be connected with the media device 101 and the like, and the user interface unit 5 that communicates various information with the user (operator).

The RAM 17 can store the image data that has been compressed by the compressing and decoding unit 19 in a coded data form. The compressing and decoding unit 19 compresses as needed the image data that has been inputted and outputs as the coded data, and expands the coded data and restores the image data. The compressing and decoding unit 19 can also be realized as a software component such as a program executed by the computer main part 11. The scanner unit 21 is configured by an imaging sensor such as a CCD, a slider control, various image processing controls and the like, and reads a document optically to convert the document into electric signals (electronic data). The printer unit 23 is configured by an engine control such as laser and ink-jet, and outputs the image expressed by the electric signals (electronic data) onto recording paper. The user interface unit 5 may be configured by the LCD with a touch panel and a hardware key. In this case, the LCD configures the display unit 5a, and the touch panel and the hardware keys configure the input unit 5b. Herein, the input unit 5b configured on the touch panel is referred to as software keys. The input unit 5b of the user interface unit 5 is configured by a numerical keypad, a start key, an LCD (liquid crystal display) and the like, and the user can carry out a mode selection, input of various settings, input of instructing to execute a process and the like.

### <Functional Configuration of MFP>

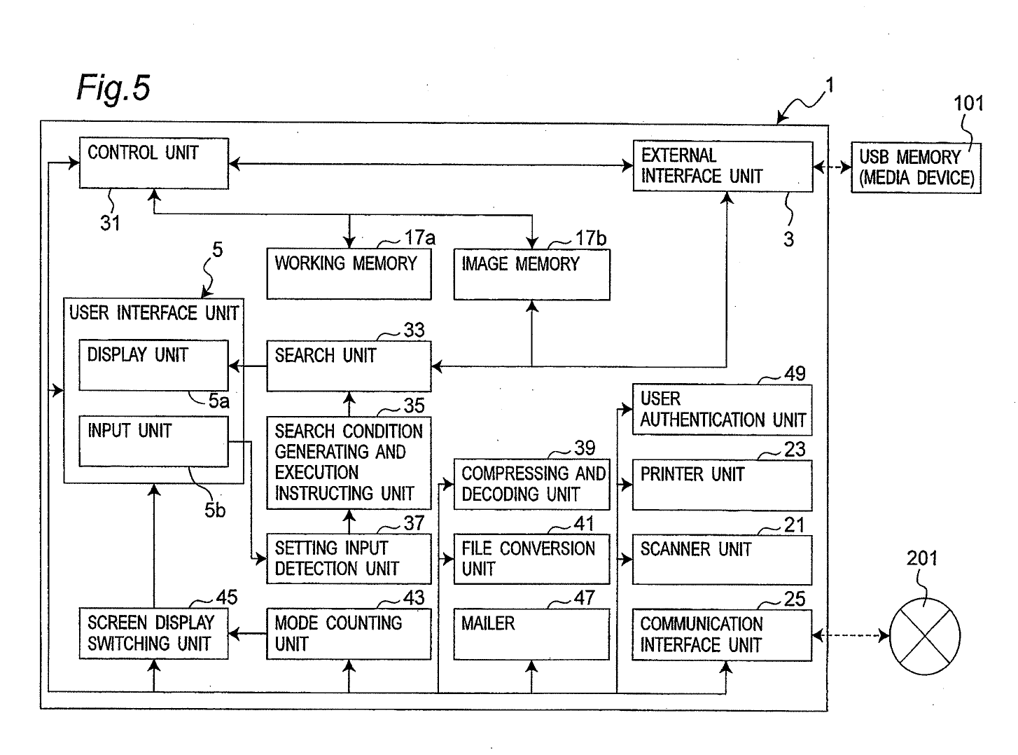

FIG. 5 is a block diagram illustrating an outline of a functional configuration of the MFP 1 according to the present embodiment. In FIG. 5, in addition to the hardware components shown in FIG. 4, functions realized as software by programs executed by the computer main part 11 are shown as blocks. A control unit 31 has a function of controlling the MFP 1 as a whole. The control unit 31 is realized by at least one program and program module, and data stored in the ROM 15 and the like and read and executed by the CPU 13 and peripheral circuits (not shown) as well as workings of data that are temporarily stored in the RAM 17 such as parameters. While the program and program module are stored in the ROM 15 in the case of the MFP 1, the present invention is not limited to such an embodiment. The program and program module may be provided through the communication interface unit 25 or the external interface unit 3. Alternatively, a part of the program and program module may be executed by the external information processing apparatus, and the control unit 31 of the MFP 1 may communicate an execution instruction and an execution result with the external information processing apparatus, thereby acquiring the result. For example, the part of the program and program module may be executed as a printer driver of a personal computer. In such a case, the user interface unit (also referred to as “UI unit”, hereafter) may be configured within a user interface provided for the personal computer. The input unit 5b of the UI unit 5 accepts a setting input (such as modification of setting values of the setup items) made by the operator (user), and outputs the accepted inputs to a setting input detection unit 37 and the control unit 31. The setting input detection unit 37 (also referred to as “detection unit”, hereafter) monitors the input unit 5b of the UI unit 5, and, when the setting input is inputted through the input unit 5b, outputs the setup item and the content that has been set relating to the input to a search condition generating and execution instructing unit 35. The search condition generating and execution instructing unit 35 (also referred to as “generating and instructing unit”, hereafter) generates a search condition based on the setup configuration inputted by the operator through the input unit 5b of the UI unit 5 and the like, and outputs the search condition and a search execution instruction to a search unit 33. The search unit 33 searches the data files stored in the memory area such as the media device 101 and the image memory 17b based on a predetermined search condition, and outputs a search result. For example, the search unit 33 can search for a data file in the media device 101 according to the search condition and the search execution instruction inputted from the generating and instructing unit 35, and display the search result in the display unit 5a of the UI unit 5. A mailer 47 is a module (application for sending and receiving e-mails) 6 that sends and receives e-mails. A file conversion unit 41 is a module that carries out various file conversion of file formats and the like of the image data and e-mails. A user authentication unit 49 is a module and hardware that stores information used for user authentication as data, and carries out user authentication as needed. A mode counting unit 43 is a module that counts the number of times in which the currently set mode has been set and a total number of usages of the machine. A screen display switching unit 45 is a module that modifies a size of the software key and a display layout displayed in the display unit 5a according to usage frequency information from the mode counting unit 43 in a stepwise fashion. In the MFP 1, the functional blocks and the hardware blocks described above operate in a cooperative manner under the integrated control of the control unit 31.

### <Flow Chart of Process>

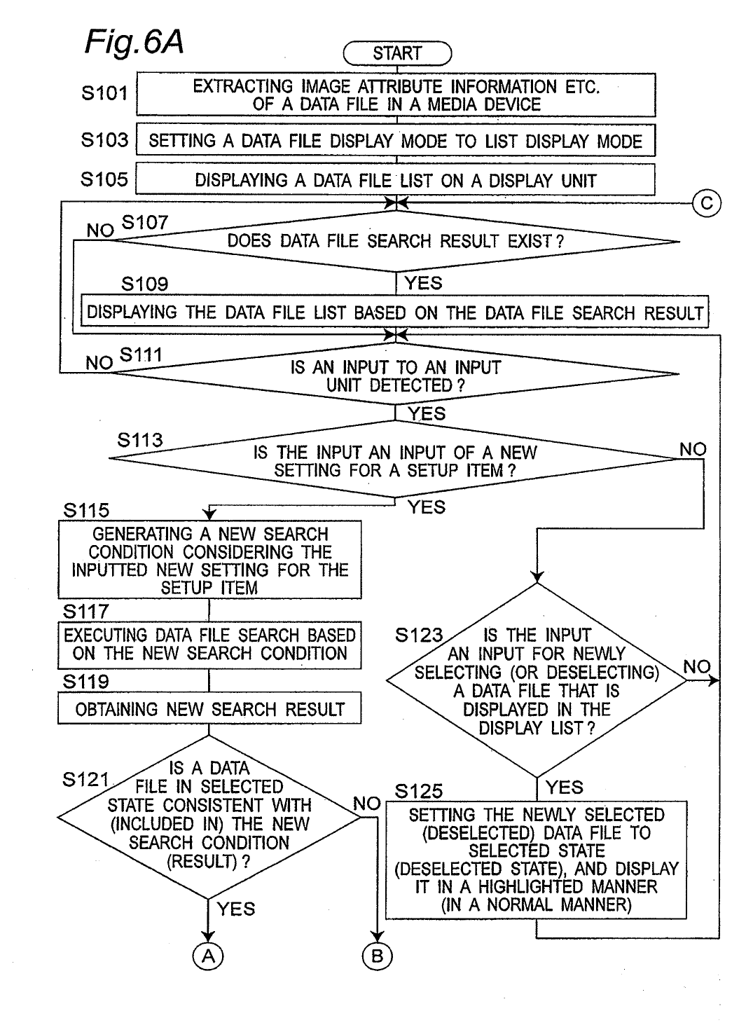

FIG. 6A and FIG. 6B are flow charts related to the data file search according to the present embodiment and the image processing using the selected data file.

The media device 101 is connected to the MFP 1 via the external interface unit 3 of the MFP 1.

In Step S101, the MFP 1 extracts image attribute information of a data file and the like stored in the media device 101. The image attribute information and the like includes a file name of the data file, a file path, a directory configuration of the media device, and file management information (time and date of file creation, file size, and the like), as well as the attributes, the attribute values and the like shown in FIG. 2.

In Step S103, the MFP 1 sets a data file display mode to a list display mode. This step may be considered as a part of an initial setting step for displaying a result of the data file search.

In Step S105, the MFP 1 displays a list of the data files in the media device on the display unit 5a using the image attribute information and the like acquired in Step S101.

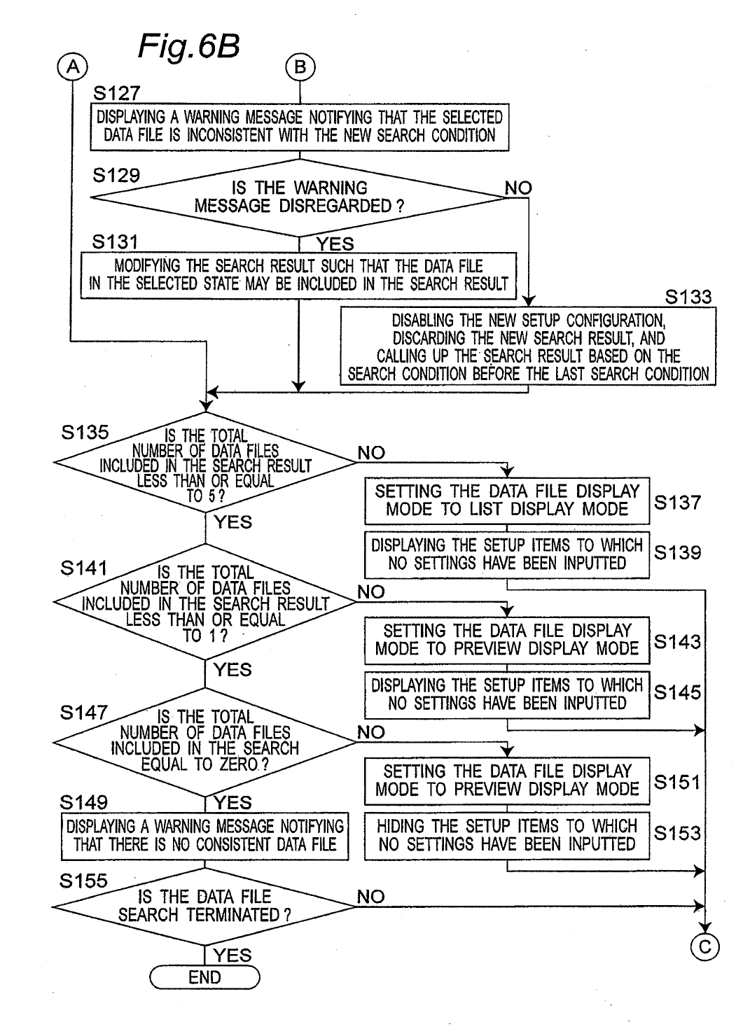

FIG. 7 is an example of a data file list 53 displayed on the display unit 5a in Step S105. At this time, the MFP 1 has not accepted any setting input from the operator. Accordingly, the MFP 1 has not carried out the data file search. As a result, in the display unit 5a, a group of data files in the media device are listed in alphabetical order. When a total number of the data files is too large to be displayed on the display unit 5a at once, the MFP 1 displays the list of the group of data files partially. At this time, a setting input keypad 51 is displayed in the display unit 5a, in addition to the data file list 53. It is to be understood that the touch panel of the input unit 5b functions as a software key that corresponds to the setting input keypad 51. The setting input keypad 51 includes: a tray selection key 51a for selecting sheets of paper used for print out; a magnification ratio key 51b for setting a magnification ratio of enlargements and reductions in printing; a color selection key 51c for selecting a color setup in printing; a stapling position key 51d for setting stapling processing to a printed matter; and a punching process key 51e for setting punching processing to the printed matter. A “NEXT” key (51f) is a key that is pressed down when the print setup is completed, for switching the display in the display unit 5a to a display for the next phase.

Referring back to FIG. 6A, in Step S107, the MFP determines whether or not a result of the data file search for the media device 101 is stored in the MFP 1. Generally, when the process moves to Step S107 from Step S101 through Step S105, the result of the data file search has not been stored in the MFP 1 (“NO” in Step S107), and the process proceeds to Step S111. When the MFP 1 determines that the result of the data file search for the media device 101 has been stored in the MFP 1 (“YES” in Step S107), the process proceeds to Step S109.

In Step S109, the MFP 1 displays a list of data files in the display unit 5a based on the stored result of the data file search.

In Step S111, the MFP 1 determines whether or not an input has been made to the input unit 5b. When the MFP 1 determines that an input to the input unit 5b has been made (“YES” in Step S111), the process proceeds to Step S113. When the MFP 1 determines that an input to the input unit 5b has not been made (“NO” in Step S111), the process returns to Step S107.

In Step S113, the MFP 1 determines whether or not the input is for inputting a new setting value for the setup item. As used herein, the inputting of a new setting value for a setup item means, for example, inputting a setting value by the operator operating the setting input keypad 51. When the MFP 1 determines that the input is for inputting a new setting value for a setup item (“YES” in Step S113), the process proceeds to Step S115. At this time, the detection unit 37 (FIG. 5) outputs information of the new setting value relating to the input to the generating and instructing unit 35 (FIG. 5). When the MFP determines that the input is not for inputting a new setting value for a setup item (“NO” in Step S113), the process proceeds to Step S123.

In Step S115, the generating and instructing unit 35 (FIG. 5) generates a new search condition based on a current setup configuration including the new setting value received from the detection unit 37 (FIG. 5). Specifically, the generating and instructing unit 35 generates a search condition so that, with the generated condition, it is possible to extract a data file whose all data file attribute's attribute values corresponding to any one of the setup items being currently set in the MFP 1 (for example, a setup item that has been modified from a default setting value by the operator) are consistent with the current setup configuration. The generated search condition is transmitted to the search unit 33 (FIG. 5). In addition, the generating and instructing unit 35 transmits a search execution instruction to the search unit 33.

In Step S117, the search unit 33 (FIG. 5) executes the data file search to the data files stored in the media device 101 (for example, FIG. 2) based on the search condition received from the generating and instructing unit 35 (FIG. 5).

In Step S119, the search unit 33 obtains a result of the search executed in Step S117.

Here, before describing the steps of Step S121 and thereafter, an example of displaying the search result obtained in S119 on the display unit 5a is described. This displaying is carried out through a predetermined process when returning to Step S109 from Step S119.

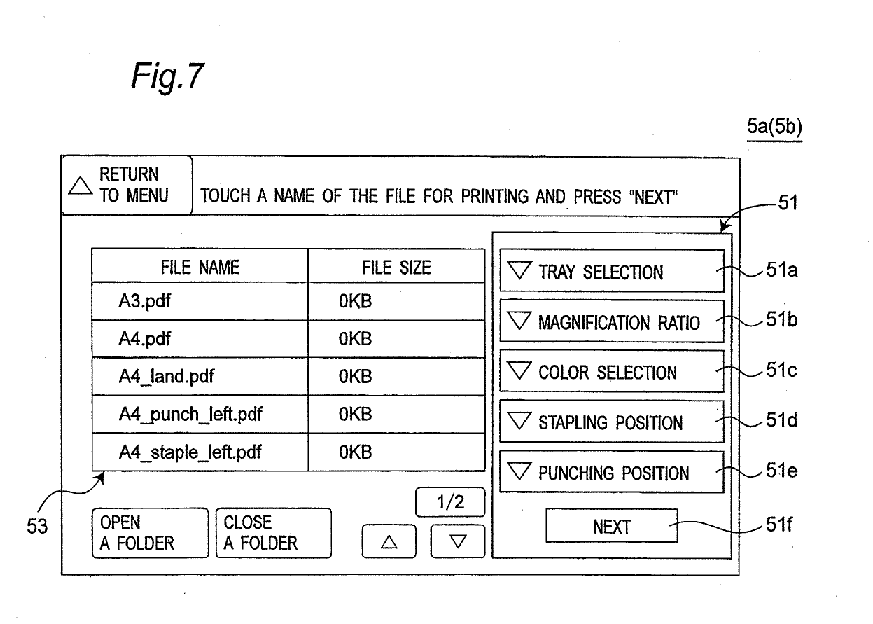

FIGS. 8, 9, 10, and 11 are display examples of the data file list displayed on the display unit 5a based on the search result that the MFP 1 has obtained in Step S119.

In Step S109, the MFP 1 displays the search result obtained in S119 on the display unit 5a, in a display mode that is selected in Step S137 (described below), Step S143 (described below), or in Step S151 (described below).

FIG. 8 is the display example of the data file list that is displayed on the display unit 5a in Step S109, in which a paper feed tray “tray 3” is selected using the tray selection key 51a in Step S111 in a situation shown in FIG. 7 where any setting input by the operator has not been accepted, and then the search result is obtained in Step S119. Referring to FIG. 8, the tray selection key 51a is assigned with an icon 61 that indicates the setting input has been made by the operator, and the data file list that are appropriate to be printed out on paper in the tray 3 (paper of A4 size sheets) is displayed in the data file list 53. In other words, a list of the data files whose attribute value for the attribute “original size” is “A4” (see FIG. 2) is displayed in the data file list 53.

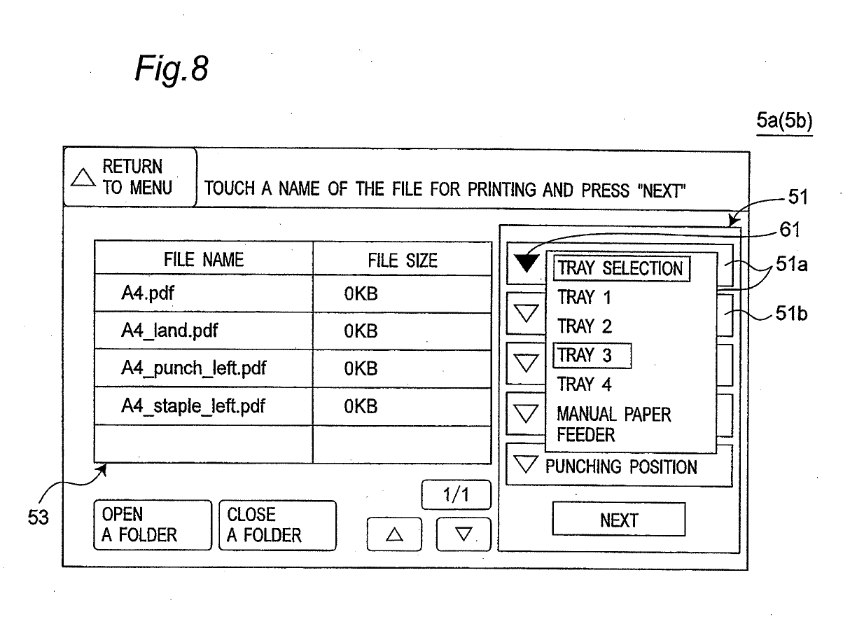

FIG. 9 is the display example of the data file list that is displayed on the display unit 5a in Step S109, in which a magnification ratio of 71% is selected using the magnification ratio key 51b in Step S111 in the situation of FIG. 8, that is, the situation where the paper feed tray “tray 3” is selected by the operator, and then the search result is obtained in Step S119. Referring to FIG. 9, the tray selection key 51a and the magnification ratio key 51b are each assigned with the icon 61 that indicates the setting input has been made by the operator, and the data file list that are appropriate to be printed out on paper in the tray 3 (paper of A4 size sheets) in the magnification ratio of 71% is displayed in the data file list 53. In other words, a list of the data files whose attribute value for the attribute “original size” is “A3” (see FIG. 2) is displayed in the data file list 53. When both the original size and the magnification ratio are set in this manner, the MFP 1 can determine the value of the original size to be included in the search condition considering the magnification ratio. In this example, the data files that are appropriate to be printed out on the paper of A4 size sheets in the magnification ratio of 71%, that is, the data files whose original size is A3 are displayed in the list. Alternatively, data files whose attribute “original size” is set to be the attribute value “A4” and whose attribute “magnification ratio” is set to be the attribute value “71%” may be added to the list of the data files.

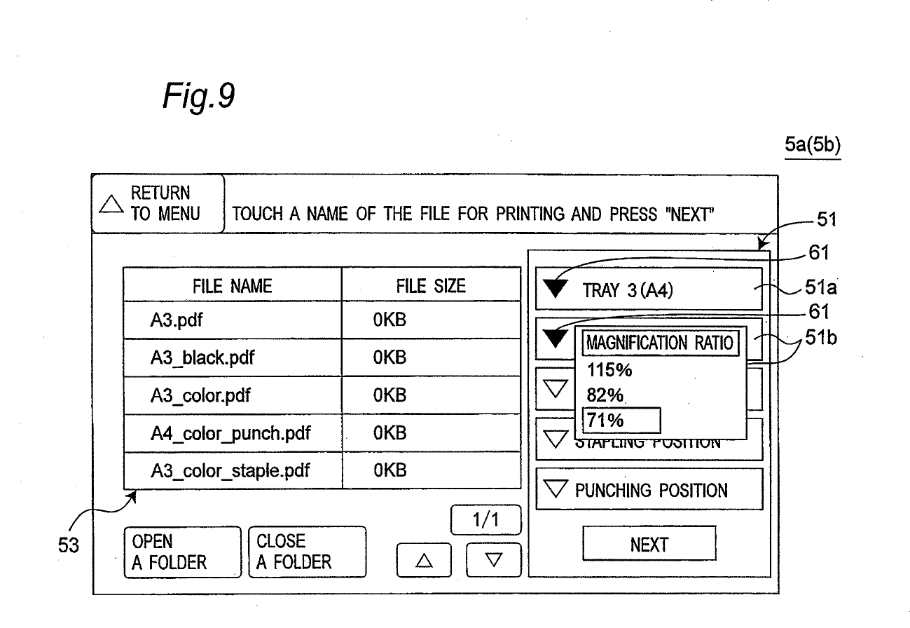

FIG. 10 is the display example of the data file list that is displayed in the display unit 5a in Step S109, in which “full-color” is selected using the color selection key 51c in Step S111 in the situation shown in FIG. 9, that is, the situation where the paper feed tray “tray 3” and the magnification ratio “71%” are selected by the operator, and then the search result is obtained in Step S119. Referring to FIG. 10, the tray selection key 51a, the magnification ratio key 51b, and the color selection key 51c are each assigned with the icon 61 that indicates the setting input has been made by the operator, and the data file list that are appropriate to be printed out on paper in the tray 3 (paper of A4 size sheets) in full-color in the magnification ratio of 71% is displayed in the data file list 53. In other words, a list of the data files whose attribute value for the attribute “original size” is “A3” and whose attribute value for the attribute “color selection” is “full-color” (see FIG. 2) is displayed in the data file list 53.

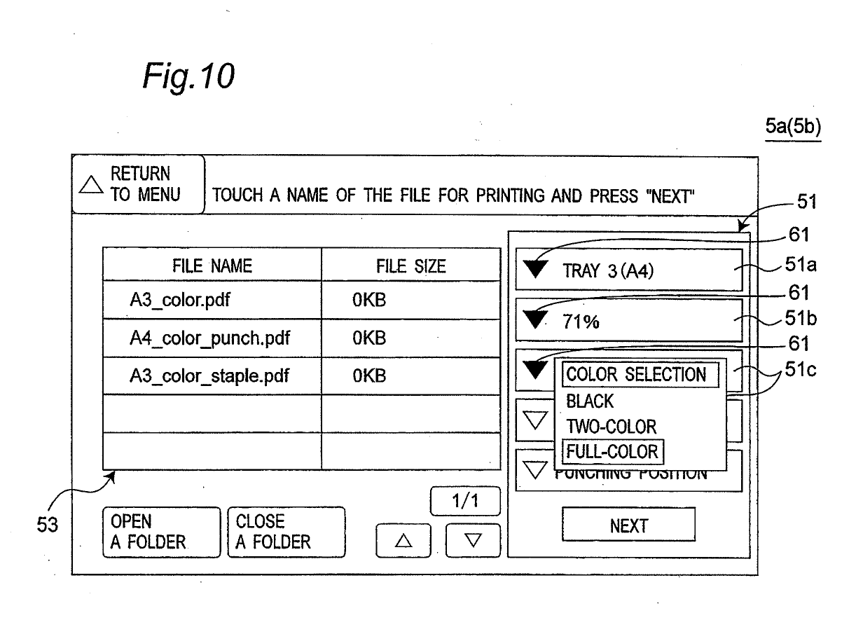

FIG. 11 is the display example of the data file list that is displayed in the display unit 5a in Step S109, in which “left bottom” is selected by the stapling position key in Step S111 in the situation shown in FIG. 10, that is, the situation where the paper feed tray “tray 3”, the magnification ratio “71%”, and the color selection “full-color” are selected by the operator, and then the search result is obtained in Step S119. Referring to FIG. 11, the tray selection key 51a, the magnification ratio key 51b, the color selection key 51c, and a stapling position 51d are each assigned with the icon 61 that indicates the setting input has been made by the operator, and a list of the data files that are appropriate to be printed out on paper in the tray 3 (paper of A4 size sheets) in full-color in the magnification ratio of 71% and are appropriate to go through the stapling processing at the “left bottom” of the outputted matter is displayed in the data file list 53. In other words, a list of the data files whose attribute value for the attribute “original size” is “A3”, whose attribute value for the attribute “color selection” is “full-color”, and whose attribute value for the “stapling position” is “left bottom” (see FIG. 2) is displayed in the data file list 53.

As described above, according to the MFP 1 of the present embodiment, the search condition is generated again every time when the operator inputs the setting (including the modification), the data file search is automatically executed based on the latest search condition, and then the result of the search is displayed in the display unit 5a.

Now, referring back to FIG. 6A, the steps of Step S121 and thereafter is described.

### <Selection, and Deselection of Data Files by Operator>

In the MFP 1 of the present embodiment, the operator can select/deselect a data file that is displayed in a list by touching the display unit 5a (the input unit 5b). Steps S123 and S125 are the steps carried out by the MFP 1 when the operator selects/deselects a data file.

In Step S123, the MFP 1 determines whether or not the input is for selecting or deselecting the data file that is displayed in a list. When the MFP 1 determines that the input is for selecting or deselecting the data file that is displayed in a list (“YES” in Step S123), the process proceeds to Step S125. When the MFP 1 determines that the input is not for selecting or deselecting the data file that is displayed in a list (“NO” in Step S123), the process proceeds to Step S111.

In Step S125, the MFP 1 changes a selection status of the data file relating to the input to a selected state (deselected state) and stores the state after the modification, and displays the data file in the selected state (deselected state) in the data file view.

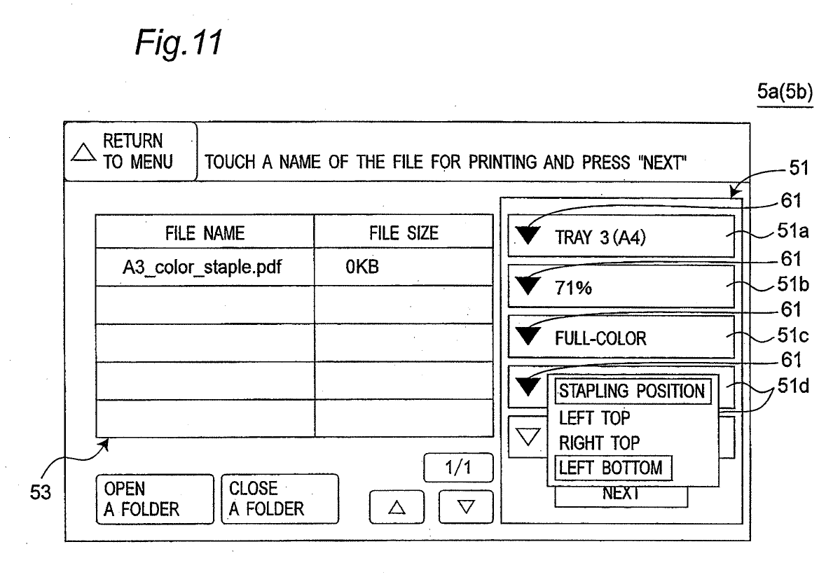

FIG. 12 is a display example of the data file in the selected state. The selected file 71 is displayed in the data file list 53 in a manner visually identifiable from data files in the deselected state by a predetermined hue and background color.

In Step S121, the MFP 1 determines whether or not the data file in the selected state is included in a search result of the search that has been carried out last time. As used herein, the data file in the selected state indicates the data file that the operator has selected through the UI unit 5. When there is no data file that is in the selected state, it is determined that a data file that is in the selected state and is not consistent with the search condition is not present, and the process proceeds to Step S135 (“YES” in Step S121). When the MFP 1 determines that the data file in the selected state is included in a search result of the search that has been carried out last time (“YES” in Step S121), the process proceeds to Step S135. When the MFP 1 determines that the data file in the selected state is not included in a search result of the search that has been carried out last time (“NO” in Step S121), the process proceeds to Step S127.

### <Handling of Selected Data File>

Referring to FIG. 6B, Steps S127, S129, S131, and S133 are the steps carried out by the MFP 1, when the data file in the selected state is not included in the new search result obtained in Step S119 (a case corresponding to “NO” in Step S121).

In Step S127, the MFP 1 displays a warning message notifying that the file in the selected state is not consistent with the new search condition. In addition to displaying of the warning message, the MFP 1 accepts modification of the setup configuration by the operator.

When the operator does not change the setup configuration, the MFP 1 determines that the operator has disregarded the warning message in Step S129 (“YES” in Step S129), and the process proceeds to Step S131. When the operator changes the setup configuration, the MFP 1 determines that the operator has accepted the warning message in Step S129 (“NO” in Step S129), and the process proceeds to Step S133.

In Step S131, the search result obtained in Step S119 is modified by adding the data file in the selected state to the search result.

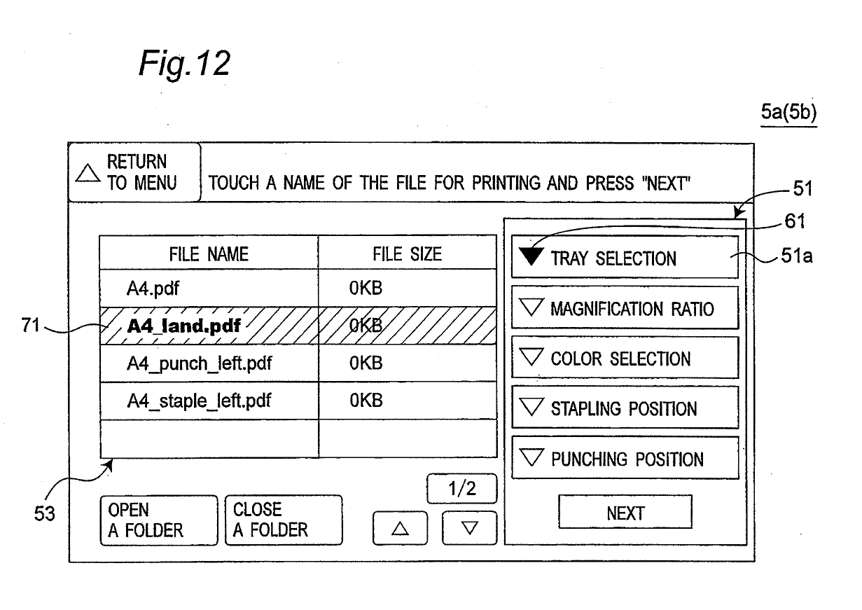

As described above, due to an additional setting input made by the operator after selecting the data file in the data file list 53, a case where the data file in the selected state is not consistent with the current search condition may occur. FIG. 13 is a display example of the data file list 53 of the display unit 5a in such a case. FIG. 13 is an example of the display unit 5a in a situation in which a warning message 81 is displayed (Step S127) but the setup configuration has not been modified. In this case, as shown in FIG. 13, the MFP 1 configures the data file list 53 by adding the data file in the selected state to the new search result (Step S131).

In Step S133, the latest search result is discarded, and the search result based on the search condition corresponding to the setup configuration after modification by the operator in Step S129 (for example, the search result obtained by the search that has been executed before the last search) is called and set as the current search result.

<Display Configuration Switching Processing based on Number of Searched Data Files>

Steps S135, S137, S139, S141, S143, S145, S147, S149, S151, and S153 are the steps for, based on the number of the data files included in the search result, switching a display configuration of the data file list between displaying by means of a list of file names and displaying by means of previews, and displaying a warning message. Referring to FIG. 6B, in Step S135, the MFP 1 determines whether or not a total number of the data files included in the search result is less than or equal to 5. While it is described as “less than or equal to 5” in the present embodiment, an arbitrary integer value N1 greater than or equal to 2 may be used as a threshold value for the determination, as long as it is within a number that is adequate for displaying the data files in the search result in the display unit 5a by previews. When the MFP 1 determines, that the total number of the data files included in the search result is less than or equal to 5 (“YES” in Step S135), the process proceeds to Step S141. When the MFP 1 determines that the total number of the data files included in the search result is not less than or equal to (which is, the number is greater than or equal to 6) (“NO” in Step S135), the process proceeds to Step S137.

In Step S141, the MFP 1 determines whether or not the total number of the data files included in the search result is less than or equal to 1. When the MFP 1 determines that the total number of the data files included in the search result is less than or equal to 1 (“YES” in Step S141), the process proceeds to Step S147. When the MFP 1 determines that the total number of the data files included in the search result is not less than or equal to 1 (“NO” in Step S141), the process proceeds to Step S143.

In Step S147, the MFP 1 determines whether or not the total number of the data files included in the search result is zero. When the MFP 1 determines that the total number of the data files included in the search result is zero (“YES” in Step S147), the process proceeds to Step S149. When the MFP 1 determines that the total number of the data files included in the search result is not zero (“NO” in Step S147), the process proceeds to Step S151.

### <<Display of List of File Names>>

Steps S137 and S139 are the steps for setting processing of the display configuration of the display unit 5a when the total number of the data files included in the search result is greater than or equal to 6. In Step S137, the MFP 1 sets the data file display mode to the list display mode. The list display mode is a display mode for displaying the search result in the display unit 5a by a list of file names. This display mode is advantageous when the number of files to be displayed is relatively large.

In Step S139, the MFP 1 sets the display configuration such that all the keys including a key that is not operated by the operator out of the keys 51a to 51e included in the setting input keypad 51 of the input unit 5b (FIG. 7) are displayed as shown in FIG. 7. When a plurality of data files is included in the search result, as further refinement for the data file search may be expected by inputting additional setting for a setup item that has not been set, the MFP 1 leaves a key for the setup item that has not been set displayed in the display unit 5a. On the other hand, when there is only one data file remaining in the search result, as further refinement for the data file search cannot be expected even if the key for the setup item that has not been set is displayed to wait for the input by the operator, the MFP 1 automatically removes the key for the setup item that has not been set from the display unit 5a. Alternatively, the MFP 1 can search for an attribute value of an attribute that corresponds to the setup item that has not been set in the data files included in the search result, and the MFP 1 may remove the key corresponding to the setup item that has not been set from the display unit 5a if it is expected that the number of files included in the search result is zero when the setup item that has not been set is set. In this case, it is not necessary to consider the total number of data files included in the current search result.

### <<Display of Preview Images>>

Steps S143 and S145 are the steps for setting processing of the display configuration of the display unit 5a when the total number of the data files included in the search result is less than or equal to 5 and greater than or equal to 2. In Step S143, the MFP 1 sets the data file display mode to a preview display mode. The preview display mode is a display mode for displaying the search result in the display unit 5a using preview images of the data files. This display mode is advantageous when the number of files to be displayed is relatively small.

In Step S145, the MFP 1 sets the display configuration such that all the keys including a key that is not operated by the operator out of the keys 51a to 51e included in the setting input keypad 51 of the input unit 5b (FIG. 7) are displayed as shown in FIG. 7.

Steps S151 and S153 are the steps for setting processing of the display configuration of the display unit 5a when the total number of the data files included in the search result is 1. In Step S151, the MFP 1 sets the data file display mode to the preview display mode.

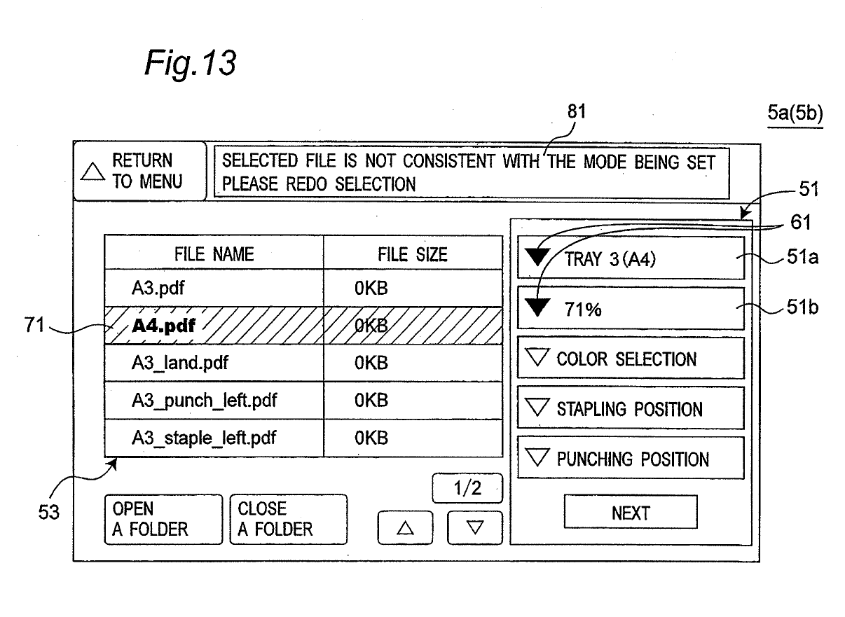

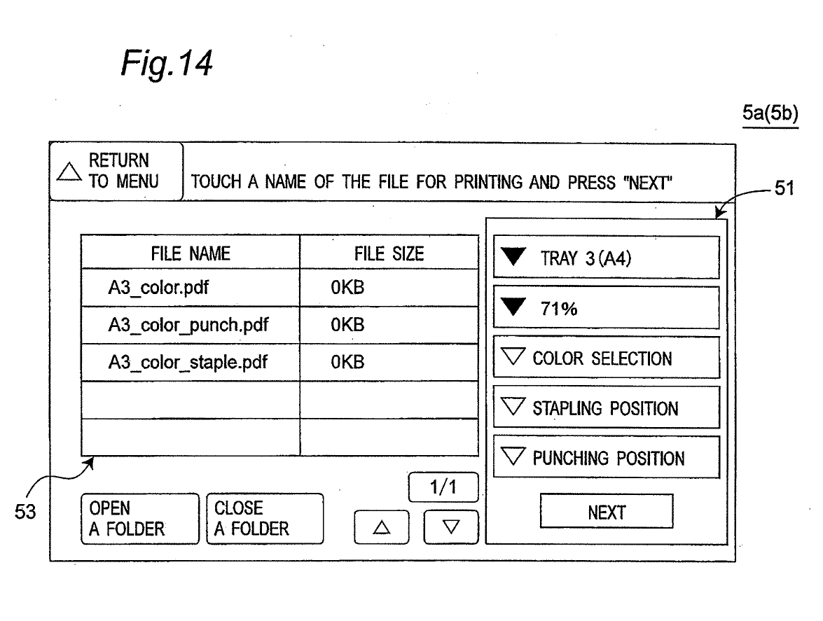

FIG. 14 is an example of the data file list 53 when the data file display mode is the list display mode. In contrast, FIG. 15 is an example of a data file list 53p when the data file display mode is the preview display mode. In this manner, when the total number of data files included in the search result is less than or equal to a predetermined number (less than or equal to an appropriate number for displaying previews), the MFP 1 sets the display of the data file list 53p to the preview display mode. In this manner, it is possible for the operator to easily select an intended file without any knowledge about the file name.

In Step S153, the MFP 1 sets the display configuration such that the keys including a key that is not operated by the operator out of the keys 51a to 51e included in the setting input keypad 51 of the input unit 5b (FIG. 7) are not displayed. When only one data file is included in the search result, further refinement for the data file search cannot be expected even if the key for the setup item that has not been set is displayed to wait for the input by the operator. Accordingly, the MFP 1 automatically removes the display of the key for the setup item that has not been set from the display unit 5a.

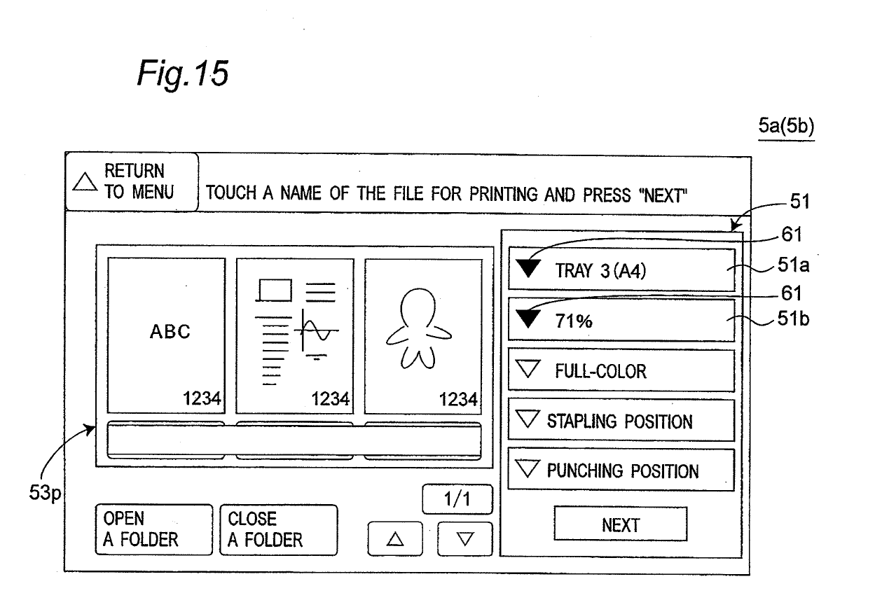

FIG. 16 is an example in which an unselected setup item is set to be not displayed in Step S153 (FIG. 6B). As shown in FIG. 16, only one file is displayed in the data file list 53. In such a case, the MFP 1 does not display a setup item to which the input by the operator has not been made in Step S153 (FIG. 6B). In this example, the punching process key 51e is not displayed (63). Alternatively, the key of the setup item that has not been inputted may be displayed in a gray out state, instead of removing the display for the key.

### <<Display of Warning Message>>

Step S149 is the step carried out by the MFP 1 when the total number of the data files of the search result is zero. In Step S149, the MFP 1 displays a message in the display unit 5a for notifying the operator that there is no data file that satisfies the current search condition, that is, the current setup configuration.

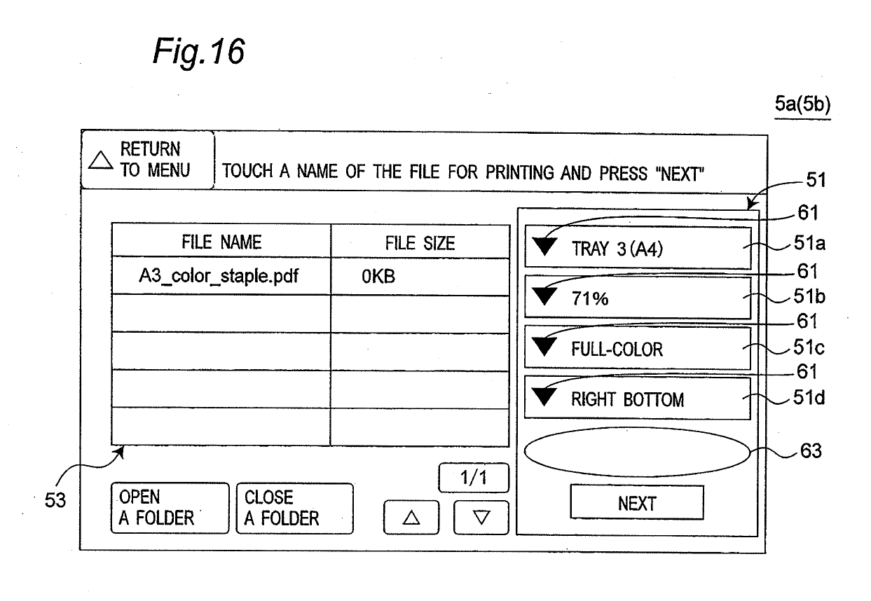

FIG. 17 is a display example of the display unit 5a when the total number of data files in the search result is zero. As shown in the figure, a warning message 83 is displayed in the display unit 5a, and the key (51b) corresponding to a setup item that has been added last time is shown highlighted. In this manner, the operator can learn which setup item has caused the number of data files in the search result to be zero.

In Step S155, the MFP 1 determines based on a predetermined condition whether the process for the data file search is to be terminated or continued. When the MFP 1 determines that the data file search process is to be terminated (“YES” in Step S155), the process shown in this flow chart is terminated. When the MFP 1 determines that the data file search process is to be continued (“NO” in Step S155), the process returns to Step S107 (FIG. 6A).

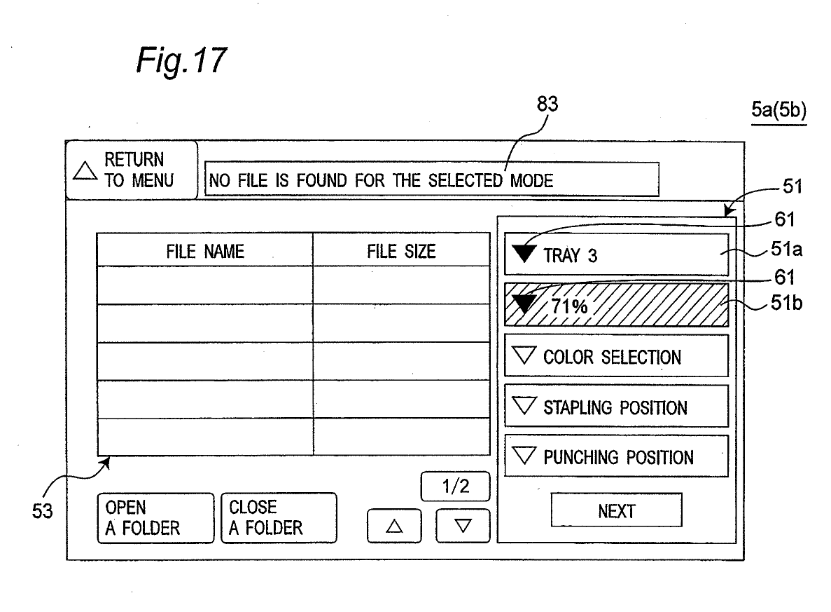

FIGS. 18, 19, and 20 are different examples of the data file search in the display unit 5a.

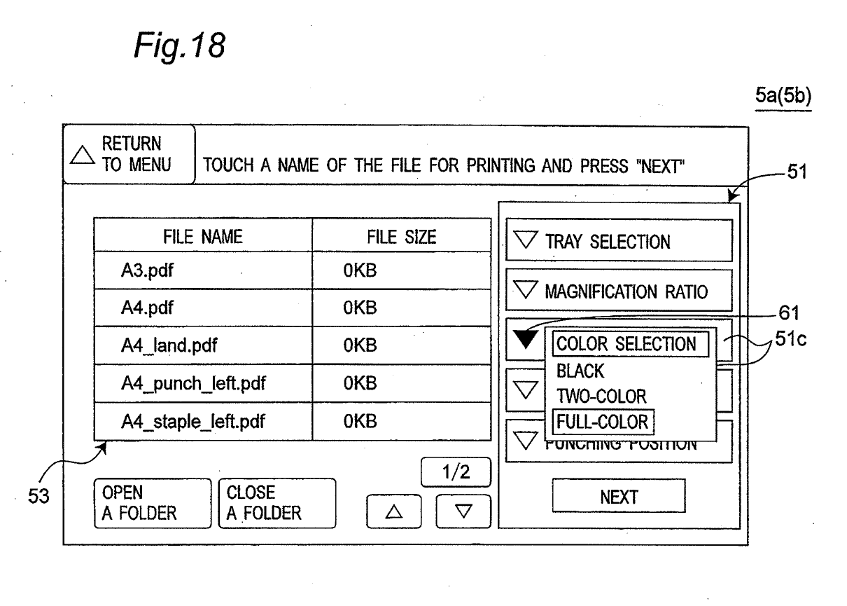

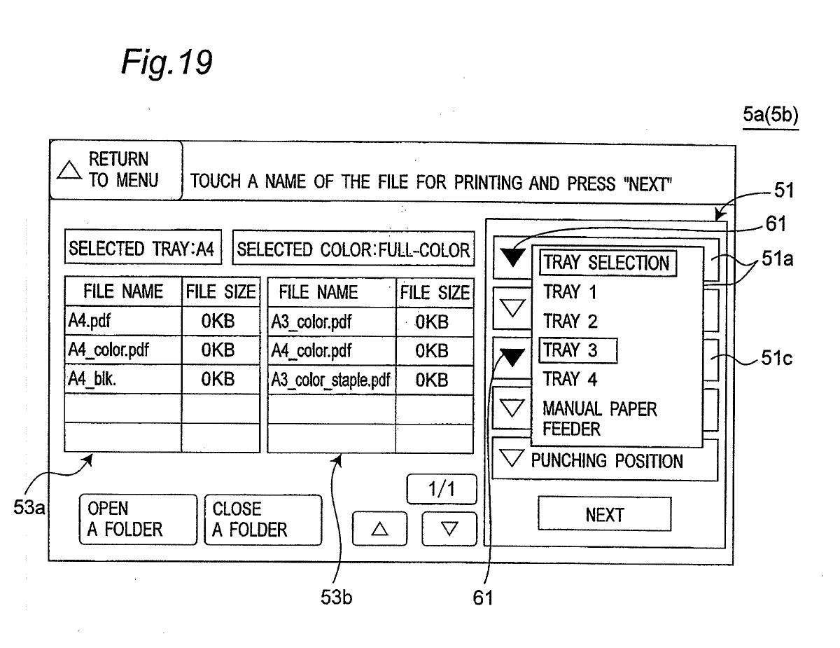

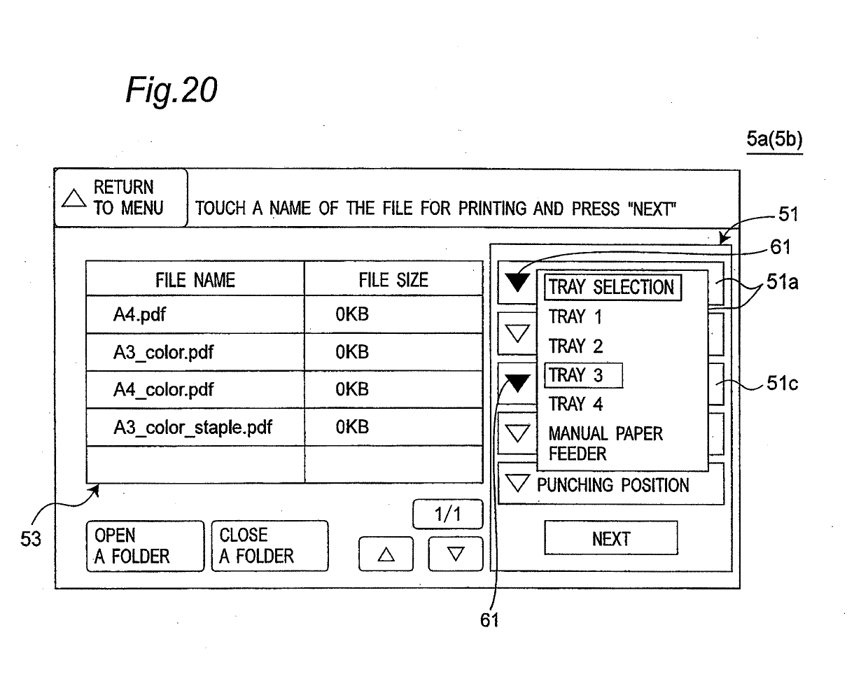

According to the MFP 1 according to the present embodiment, the operator can input setting for an arbitrary setup item, and see the result of the data file search based on the setup configuration. For example, as shown in FIG. 18, the operator can set the setting only for the color selection using the color selection key 51c, and can cause the MFP 1 to execute the data file search. In this case, the operator has selected “full-color” as the setting for the “color selection”. In the MFP 1, the color selection key 51c is assigned with the icon 61 that indicates the operator has inputted setting for this item. Then, the MFP 1 executes the data file search and displays a list of the data files whose attribute value for the attribute “color selection” is “full-color” in the list 53. Next, it is assumed that, in the situation shown in FIG. 18, the operator operates the tray selection key 51a and sets the “tray 3” as the tray of paper to be used. FIG. 19 shows the display example of the data file list 53 in which the operator has inputted setting for two setup items. At this time, it is possible that the MFP 1 generates a search condition for each of the setup items that are currently set, executes independent data file searches in parallel for each search condition, obtains a plurality of search results, and presents the search results displayed in separate lists to the operator. In FIG. 19, a data file list 53a in which the attribute value for the attribute “original size” is “A4” and a data file list 53b in which the attribute value for the attribute “color selection” is “full-color” are shown separately. Alternatively, as shown in FIG. 20, a single compound search condition for a plurality of setup items can be generated, and a data file that satisfies the compound condition in which “the original size is A4 and the color selection is full-color” can be searched and displayed in the single data file list 53. The MFP 1 may be configured, for example, such that the operator can arbitrarily select whether to execute a plurality of independent data file searches in parallel and display a plurality of lists to the operator as shown in FIG. 19, or to generate a single compound search condition from a plurality of setup items and display a single list to the operator.

An MFP of the embodiment according to the present invention is useful as an image processing apparatus that utilizes a setup configuration relating to printing processing made by a user, thereby assisting the user with operations relating to specification of data files.

With an image processing apparatus according to the present invention, a user can easily find an intended data file stored in a media device (data storage device), and quickly complete image processing using the file. The present invention provides effects of improving operability and productivity of the image processing apparatus.

As this invention may be embodied in several forms without departing from the spirit of essential characteristic thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing apparatus which executes a predetermined image processing using a data file stored in a data storage device, the image processing apparatus comprising:
an external interface unit that detachably connects with the data storage device;
an input unit that accepts a setting input for a setup item relating to the predetermined image processing;
a setting input detection unit that detects the setting input inputted through said input unit;
a search condition generating unit that generates a search condition based on a setting value that is set for the setup item relating to the predetermined image processing, when said setting input detection unit has detected the setting input;
an execution instructing unit that instructs a search unit to execute a data file search when said setting input detection unit has detected the setting input;
said search unit that, in accordance with the instruction from the execution instructing unit, executes a data file search for a data file stored in the data storage device to output a search result based on the search condition that is generated by said search condition generating unit; and
a display unit that displays the search result of the data file search.

2. The image processing apparatus according to claim 1, wherein
said search unit executes the data file search by acquiring an attribute value for an attribute of the data file relating to the search condition, and by determining whether or not the attribute value satisfies the search condition.

3. The image processing apparatus according to claim 1, wherein
said search condition generating unit generates a first search condition based on a setting value for a first setup item included in setup items relating to the predetermined image processing, and generates a second search condition based on a setting value for a second setup item included in setup items relating to the predetermined image processing, and
said search unit executes a data file search based on the first search condition and a data file search based on the second search condition, and outputs a first search result and a second search result for the respective data file searches.

4. The image processing apparatus according to claim 1, wherein
said input unit further accepts a selection input of a data file included in the search result displayed in said display unit.

5. The image processing apparatus according to claim 4, wherein
said search unit determines, in a situation in which the selection input of a data file has been inputted through said input unit, whether or not a data file relating to the selection is included in the search result of the executed data file search, and
said display unit displays a warning message when the data file relating to the selection is not included in the search result of the data file search.

6. The image processing apparatus according to claim 4, wherein
said search unit modifies and outputs the search result when a data file relating to the selection is not included in the search result of the data file search, so that the search result includes the data file relating to the selection.

7. The image processing apparatus according to claim 1, wherein
said search unit generates a search condition which said search condition generating unit generates in case where a setup item that has not been set among the setup items relating to the predetermined image processing is set, and derives a total number of data files included in the search result of the data file search based on the generated search condition, and
said display unit does not accept the setting input for the setup item that has not been set when the total number of data files is zero.

8. The image processing apparatus according to claim 1, wherein
said display unit displays a preview image of a data file included in the search result when a total number of data files included in the search result is less than or equal to a predetermined number.

9. An image processing method in an image processing apparatus which executes a predetermined image processing using a data file stored in a data storage device, the image processing method comprising:
accepting a setting input for a setup item relating to the predetermined image processing by an input unit;
detecting the setting input inputted through the input unit by a setting input detection unit;
generating a search condition based on a setting value that is set for the setup item relating to the predetermined image processing, when the setting input detection unit has detected the setting input;
instructing a search unit to execute a data file search by an execution instructing unit when the setting input detection unit has detected the setting input;
executing a data file search for a data file stored in the data storage device by the search unit, in accordance with the instruction from the execution instructing unit, to output a search result based on the search condition that is generated by the search condition generating unit; and
displaying the search result of the data file search by a display unit.

10. The image processing method according to claim 9, wherein
said executing by the search unit includes acquiring an attribute value for an attribute of the data file relating to the search condition, and determining whether or not the attribute value satisfies the search condition.

11. The image processing method according to claim 9, wherein
said generating by the search condition generating unit includes generating a first search condition based on a setting value for a first setup item included in setup items relating to the predetermined image processing, and generating a second search condition based on a setting value for a second setup item included in setup items relating to the predetermined image processing, and
said executing by the search unit includes executing a data file search based on the first search condition and executing a data file search based on the second search condition, and outputting a first search result and a second search result for the respective data file searches.

12. The image processing method according to claim 9, further comprising accepting by the input unit a selection input of a data file included in the search result displayed in the display unit.

13. The image processing method according to claim 12, further comprising
determining by the search unit, in a situation in which the selection input of a data file has been inputted in said accepting the selection, whether or not a data file relating to the selection is included in the search result of the executed data file search, and
displaying by the display unit a warning message when the data file relating to the selection is not included in the search result of the data file search.

14. The image processing method according to claim 12, further comprising modifying and outputting the search result by the search unit when a data file relating to the selection in said accepting the selection is not included in the search result of the data file search, so that the search result includes the data file relating to the selection.

15. The image processing method according to claim 9, further comprising
generating by the search unit a search condition which the search condition generating unit generates in case where a setup item that has not been set among the setup items relating to the predetermined image processing is set, and deriving a total number of data files included in the search result of the data file search based on the generated search condition, and
making the display unit not accept the setting input for the setup item that has not been set when the total number of data files is zero.

16. The image processing method according to claim 9, wherein
said displaying the search result include displaying a preview image of a data file included in the search result when a total number of data files included in the search result is less than or equal to a predetermined number.

17. A computer-readable medium having stored thereon computer executable instructions which, when executed by a computer of an image processing apparatus which executes a predetermined image processing using a data file stored in a data storage device, perform:
causing an input unit to accept a setting input for a setup item relating to the predetermined image processing;
causing a setting input detection unit to detect the setting input inputted through the input unit;
causing a search condition generating unit to generate a search condition based on a setting value that is set for the setup item relating to the predetermined image processing, when the setting input detection unit has detected the setting input;
causing an execution instructing unit to instruct a search unit to execute a data file search when the setting input detection unit has detected the setting input;
causing the search unit to, in accordance with the instruction from the execution instructing unit, execute a data file search for a data file stored in the data storage device to output a search result based on the search condition that is generated by the search condition generating unit; and
causing a display unit to display the search result of the data file search.
